(19) United States
(12) Patent Application Publication
(10) Pub. No.: US 2026/0050126 A1
(43) Pub. Date: Feb. 19, 2026

(54) LARGE FIELD-OF-VIEW FOLD-GRATING DIFFRACTIVE WAVEGUIDE

(71) Applicant: Applied Materials, Inc., Santa Clara, CA (US)

(72) Inventors: Simon LORENZO, Santa Clara, CA (US); David Alexander SELL, Santa Clara, CA (US); Samarth BHARGAVA, Saratoga, CA (US)

(21) Appl. No.: 19/300,809

(22) Filed: Aug. 15, 2025

Related U.S. Application Data
(60) Provisional application No. 63/683,482, filed on Aug. 15, 2024.

(51) Int. Cl. G02B 6/34; G02B 27/01

(52) U.S. Cl. CPC G02B 6/34; G02B 27/0172; G02B 2027/0123

(57) ABSTRACT

Embodiments of the present disclosure generally relate to augmented reality waveguides for augmented, virtual, and mixed reality. More specifically, embodiments described herein provide waveguides with a large field-of-view and a method of forming the same. In one embodiment, a waveguide is provided. The waveguide includes an incoupler (IC) grating. The incoupler (IC) grating includes a plurality of blazed structures disposed over a substrate. The plurality of blazed structures having a blazed surface with a slant angle relative to a plane parallel to the substrate. The waveguide further includes a metal material disposed over the plurality of blazed structures. An intermediate grating and an outcoupler (OC) grating each including a plurality of device structures. The plurality of device structures having a variable depth.

### CROSS-REFERENCE TO RELATED APPLICATIONS

This application claims the benefit and priority to U.S. Provisional Application 63/683,482 filed on Aug. 15, 2024, which is incorporated by reference here in its entirety.

### BACKGROUND

### Field

Embodiments of the present disclosure generally relate to augmented reality waveguides for augmented, virtual, and mixed reality. More specifically, embodiments described herein provide waveguides with a large field-of-view and a method of forming the same.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment. Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Waveguides are used to assist in overlaying images. Generated light is in-coupled into a waveguide, propagated through the augmented waveguide, out-coupled from the augmented waveguide, and overlaid on the ambient environment. Light is coupled into and out of augmented waveguides using surface relief gratings. Accordingly, what is needed in the art are waveguides with a large field-of-view.

### SUMMARY

In one embodiment, a waveguide is provided. The waveguide includes an incoupler (IC) grating. The incoupler (IC) grating includes a plurality of blazed structures disposed over a substrate. The plurality of blazed structures having a blazed surface with a slant angle relative to a plane parallel to the substrate. The waveguide further includes a metal material disposed over the plurality of blazed structures. An intermediate grating and an outcoupler (OC) grating each including a plurality of device structures. The plurality of device structures having a variable depth.

In a further embodiment, a waveguide is provided. The waveguide includes an incoupler (IC) grating. The incoupler (IC) grating further includes a plurality of blazed structures disposed over a substrate. The plurality of blazed structures having a blazed surface with a slant angle relative to a plane parallel to the substrate. The waveguide further includes a metal material disposed over the plurality of blazed structures. An outcoupler (OC) grating including a plurality of first device structures. The plurality of first device structures having a first variable depth. An intermediate grating including a plurality of second device structures. The plurality of second device structures having a variable depth.

In another embodiment, a method of forming a waveguide is provided. The method includes forming features in exposed portions of a hardmask layer. The features having an angled surface. Forming an incoupler (IC) grating including a plurality of blazed structures. The plurality of blazed structures having a blazed surface with a slant angle relative to a plane parallel to a substrate. The slant angle of the blazed structures is defined by the angled surface of the features. The method further includes forming an intermediate grating and an outcoupler (OC) grating. The intermediate grating and the outcoupler (OC) grating each including a plurality of device structures. The device structures having a variable depth. a plurality of device structures,

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a perspective, frontal view of a waveguide according to certain embodiments.

FIGS. 2A-2C are a schematic, cross-sectional views of a waveguide according to certain embodiments.

FIGS. 3A and 3B are schematic, cross-sectional views of a blazed structure, according to certain embodiments.

FIG. 4 is a flow diagram of a method of forming a waveguide, according to certain embodiments.

FIGS. 5A-5C are schematic, cross-sectional views of a portion of a substrate during a method for forming a waveguide, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to augmented reality waveguides (e.g., waveguides) for augmented, virtual, and mixed reality. More specifically, embodiments described herein provide large field-of-view fold grating diffractive waveguide and methods of forming the same. The waveguides include a plurality of gratings. Each grating may be a first grating (e.g., an incoupler), a second grating or intermediate grating (e.g., an exit pupil expansion grating or a fold grating), or a third grating (e.g., an outcoupler). The waveguide includes a plurality of device structures, (e.g., a plurality of grating structures). Regions of the plurality of device structures correspond to different gratings. The plurality of device structures of the incoupler are blazed structures (i.e., slanted gratings forming a fold grating configuration). The plurality of device structures of the exit pupil expansion grating and the outcoupler are binary structures or angled structures. The angled structures have a planar top surface and slanted sidewalls. In one or more embodiments, the incoupler is metalized (e.g., a metal material is disposed over the blazed structures of the incoupler). The plurality of device structures (hereinafter referred to as ‘device structures’) are formed by a method with operations drawn to a litho-etch process cycle. The litho-etch process cycle allows for different types of device structures to be formed over the same substrate. For example, the disclosed method allows for the incoupler to include blazed structures while the outcoupler and the exit pupil expansion grating include binary structures or angled structures. The angled structures have a planar top surface and slanted sidewalls. The varying types of device structures included on the waveguide provide a large field-of-view to enable world-locked mixed reality applications.

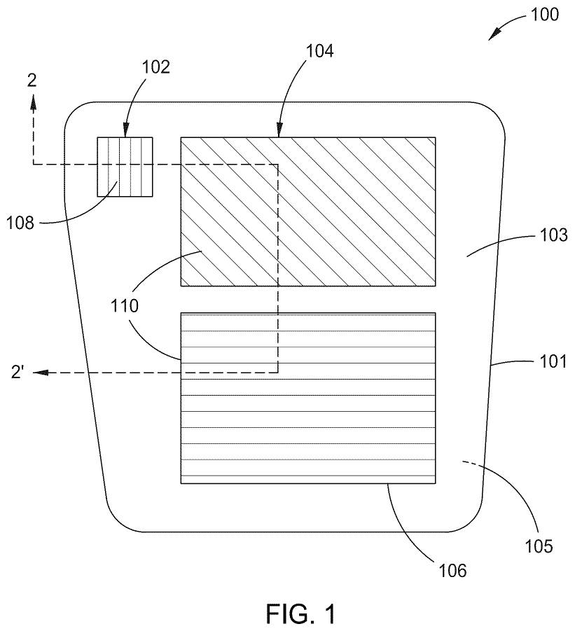

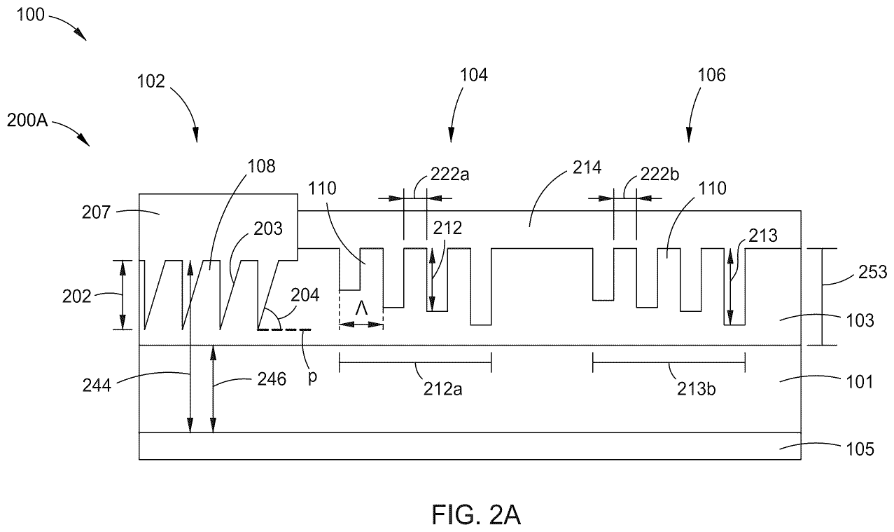

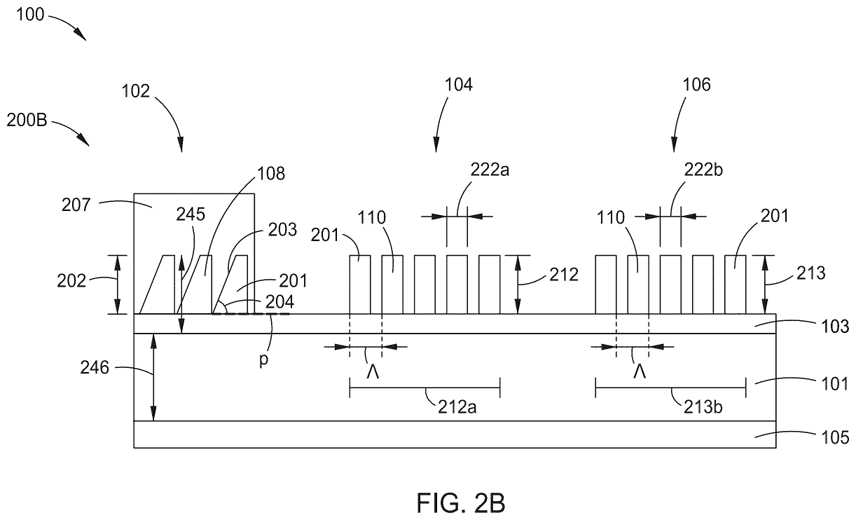

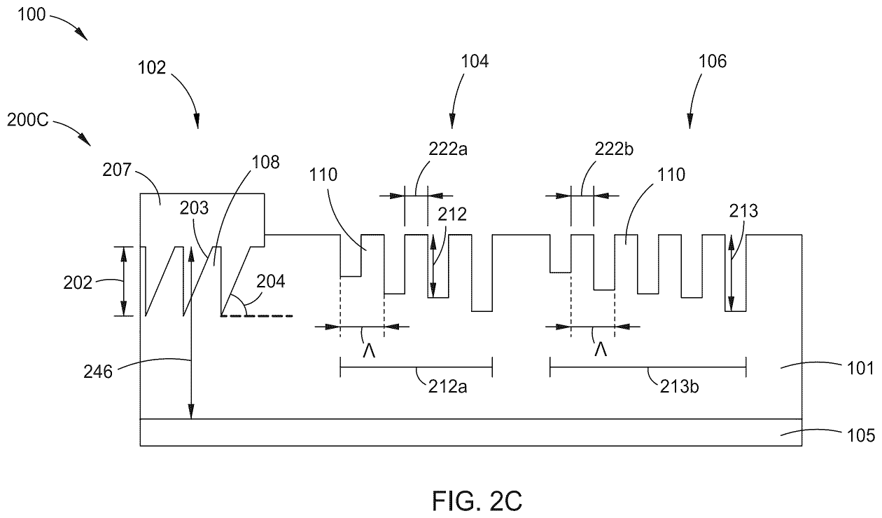

FIG. 1A is a perspective, frontal view of a waveguide 100. The waveguide 100 includes an incoupler grating 102 and an outcoupler grating 106. The waveguide 100 may further include an intermediate grating 104. The intermediate grating 104 may be an exit pupil expansion grating or a fold grating. The incoupler grating 102 includes blazed structures 108. The intermediate grating 104 and the outcoupler grating 106 include device structures 110. In some embodiments, the device structures 110 are binary structures or angled structures. The angled structures have a planar top surface and slanted sidewalls. The blazed structures 108 and the device structures 110 can be nanostructures having sub-micron dimensions, e.g., nano-sized dimensions, such as critical dimensions less than 1 μm. As shown in FIGS. 2A and 2B, the blazed structures 108 and the device structures 110 include a device material 103. The device material 103 is disposed on the substrate 101. A second-side coating 105 is disposed on a backside of the substrate 101. As shown in FIG. 2C, the blazed structures 108 and the device structures 110 are disposed in the substrate 101.

The substrate 101 can be any substrate used in the art, and can be either opaque or transparent to a chosen wavelength of light, depending for the use of the substrate 101 as a substrate for a waveguide. Substrate selection may include substrates of any suitable material, including, but not limited to, amorphous dielectrics, non-amorphous dielectrics, crystalline dielectrics, polymers, or combinations thereof. In some embodiments, the substrate 101 includes, but is not limited to, a silicon-containing material, a silicon and oxygen containing compound, a germanium-containing material, a indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, a indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. In other embodiments, which can be combined with other embodiments described herein, the substrate 101 includes an oxide including one or more of gadolinium, silicon, sodium, barium, potassium, tungsten, phosphorus, zinc, calcium, titanium, tantalum, niobium, lanthanum, zirconium, lithium, or yttrium containing-materials. Example materials of the substrate 101 include silicon (Si), silicon monoxide (SiO), silicon dioxide (SiO₂), silicon carbide (SiC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd2O₅), zinc oxide (ZnO), yttrium oxide (Y₂O₃), tungsten oxide (WO₃), titanium oxide (TiO₂), zirconium oxide (ZrO₂), sodium oxide (Na₂O), niobium oxide (Nb₂O₅), barium oxide (BaO), potassium oxide (K2O), phosphorus pentoxide (P₂O₅), calcium oxide (CaO), or combinations thereof.

The device material 103 and the substrate 101 include a different material. The device material 103 includes, but is not limited to, one or more oxides, carbides, or nitrides of silicon, aluminum, zirconium, tin, tantalum, zirconium, barium, titanium, hafnium, lithium, lanthanum, cadmium, niobium, or combinations thereof. Example materials of the device material 103 include silicon carbide, silicon oxycarbide, titanium oxide, silicon oxide, vanadium oxide, aluminum oxide, aluminum-doped zinc oxide, indium tin oxide, tin oxide, zinc oxide, tantalum oxide, silicon nitride, zirconium oxide, niobium oxide, cadmium stannate, silicon oxynitride, barium titanate, diamond like carbon, hafnium oxide, lithium niobate, silicon carbon-nitride, silver, cadmium selenide, mercury telluride, zinc selenide, silver-indium-gallium-sulfur, silver-indium-sulfur, indium phosphide, gallium phosphide, lead sulfide, lead selenide, zinc sulfide, molybdenum sulfide, tungsten sulfide, or combinations thereof.

The device material 103, the substrate 101, and the second-side coating 105 include a different material. In one or more embodiments, the second-side coating 105 and the device material include the same material. The second-side coating 105 includes, but is not limited to, silicon oxide or aluminum oxide.

FIG. 2A is a schematic, cross-sectional view of waveguide 100 along line 2-2′ shown in FIG. 1. The waveguide 100 of FIG. 2A has a first configuration 200A. A metal material 207 is disposed over the incoupler grating 102.

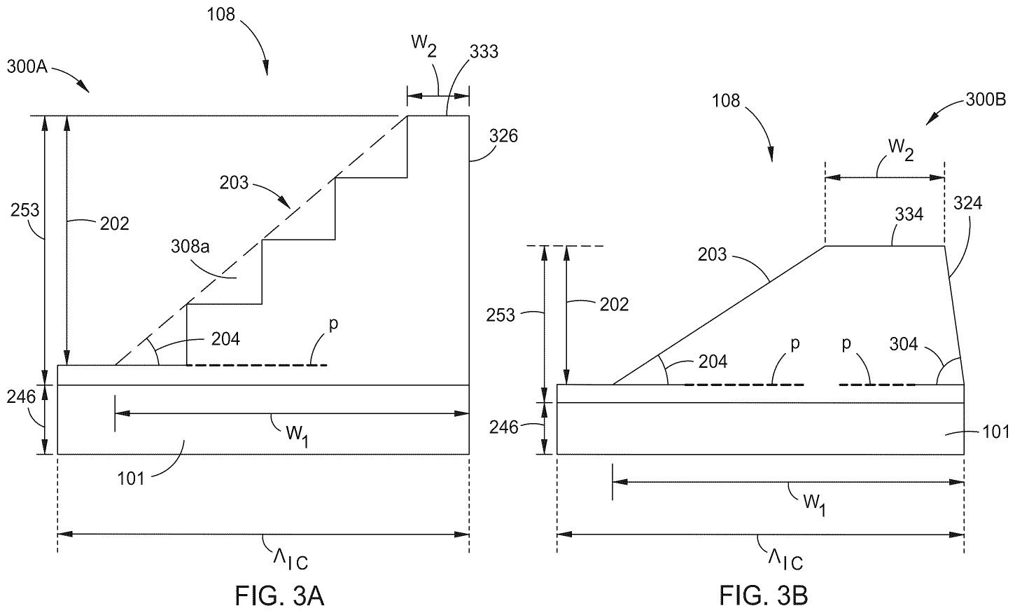

The blazed structures 108 are etched into the device material 103. The device material 103 is disposed on the substrate 101. The device material 103 has a thickness 253. In some embodiments, the thickness 253 of the device material 103 is in the range from about 75 nm to about 95 nm, such as about 80 nm. The blazed structures 108 have a depth (i.e., an etch depth) 202. In one or more embodiments, the depth 202 is in the range from about 50 nm to about 70 nm, such as 55 nm. In some embodiments, the blazed structures 108 have a variable depth. A variable depth corresponds to the depth 202 of at least two of the blazed structures 108 being different. To form an incoupler grating 102 having a variable depth, the etch depth is non-uniform. The blazed structures 108 of the incoupler grating 102 have a blazed surface 203. The blazed surface 203 is slanted at a slant angle 204. The slant angle 204 is the angle of the blazed surface 203 to a plane p parallel to the substrate 101. The slant angle 204 is in the range from about 5 degrees to about 45 degrees. For example, the slant angle 204 is in the range from about 10 degrees to about 30 degrees. As shown in FIG. 3A, the blazed surface 203 is stepped. As shown in FIG. 3B, the blazed surface 203 is substantially uniform. The total thickness 244 includes the thickness 253 of the device material 103 and the thickness 246 of the substrate 101.

The device structures 110 of the intermediate grating 104 have a depth 212. The depth 212 of the device structures 110 of the intermediate grating 104 is a variable depth. The depth 212 of the device structures 110 varies across the portion 212a of the intermediate grating 104. The depth 212 of at least two of the device structures 110 are different across the portion 212a. The device structures 110 of the outcoupler grating 106 have a depth 213. The depth 213 of the device structures 110 of the outcoupler grating 106 is a variable depth. The depth 213 of the device structures 110 varies across the portion 213b of the outcoupler grating 106. At least two of the device structures 110 are different across the portion 213b. In one example, the change in depth 212 of the device structures 110 of the intermediate grating 104 is different from the change in depth 213 of the device structures 110 of the outcoupler grating 106. In yet another example, the variable depth 212 of the device structures 110 of the intermediate grating 104 is the same as the variable depth 213 of the device structures 110 of the outcoupler grating 106. The device structures 110 are binary structures or angled structures. The angled structures have a planar top surface and slanted sidewalls.

The device structures 110 of the intermediate grating 104 and outcoupler grating 106 have a duty cycle. The duty cycle of the intermediate grating 104 is the ratio of the width 222a of device structures 110 to the period ∧ of one repeating structure 110. The device structures 110 of the intermediate grating 104 have a width 222a and period ∧. In one or more embodiments, the duty cycle of the device structures 110 of the intermediate grating 104 is a variable duty cycle (i.e., the duty cycle changes across the portion 212a). The duty cycle varies from about 0.1 to about 0.9. The device structures 110 of the outcoupler grating 106 have a width 222b and a period ∧. The duty cycle is the ratio of the width 222b of device structures 110 to the period ∧ of one repeating structure 110. In one or more embodiments, the duty cycle of the device structures 110 of the outcoupler grating 106 is a variable duty cycle (i.e., the duty cycle changes across the portion 213b). The duty cycle varies from about 0.1 to about 0.9. In some embodiments, an optional encapsulation layer is 214 is disposed over the device structures 110 of the intermediate grating 104 and of the outcoupler grating 106. In some embodiments, the encapsulation layer 214 includes a material with a low index of refraction. For example, the index of refraction of the encapsulation layer 214 is less than 2.0. In some embodiments, the encapsulation layer 214 has a variable thickness. For example, the encapsulation layer has a thickness that varies across the portions 212a and 213b. In another example, the variable thickness of the encapsulation layer 214 is defined, at least in part, by the depth 212 of the device structures 110. For example, the thickness of the encapsulation layer 214 is in the range from about 50 nm to about 100 nm.

FIG. 2B is a schematic, cross-sectional view of waveguide 100 along line 2-2′ shown in FIG. 1. The waveguide 100 of FIG. 2A has a second configuration 200B. The waveguide 100 includes an incoupler grating 102 and an outcoupler grating 106. The waveguide 100 may further include an intermediate grating 104. The intermediate grating 104 may be an exit pupil expansion grating or a fold grating. The incoupler grating 102, the intermediate grating 104, and the outcoupler grating 106 include a nano-imprint material 201. In some embodiments, as shown in FIG. 2B, the nano-imprint material 201 is disposed on the device material 103. In other embodiments, the nano-imprint material 201 is disposed on the substrate 101. The incoupler grating 102, the intermediate grating 104, and the outcoupler grating 106 of the nano-imprint material 201 are formed via a nano-imprint lithography process. The nano-imprint material 201 may be the same or different than the device material 103. The nano-imprint material includes at least one of spin-on glass (SOG), flowable SOG, organic nano imprintable, inorganic nano imprintable, and hybrid (organic and inorganic) nano imprintable materials. Example materials include such as at least one of silicon oxynitride (SiOC), titanium oxide (TiO₂), silicon oxide (SiO₂), vanadium oxide (VOₓ), aluminum oxide (Al₂O₃), indium tin oxide (ITO), zinc oxide (ZnO), tantalum pentoxide (Ta₂O₅), silicon nitride (Si₃N₄), titanium nitride (TiN), or zirconium oxide (ZrO₂) containing materials.

The incoupler grating 102 includes blazed structures 108. The intermediate grating 104 and the outcoupler grating 106 include device structures 110. The blazed structures 108 and the device structures 110 include a nano-imprint material 201. In some examples, the nano-imprint material 201 is the same as the device material 103. The device material 103 is disposed on the substrate 101. The second-side coating 105 is disposed on a backside of the substrate 101. The substrate 101 has a thickness 246. In some embodiments, the thickness 246 of the substrate 101 is in the range from about 0.3 mm to about 1.0 mm, such as 0.6 nm.

The device structures 110 are binary structures or angled structures. The angled structures have a planar top surface and slanted sidewalls. In some embodiments, the nano-imprint material 201 includes, but is not limited to, the same material as the device material 103. A metal material 207 is disposed over the incoupler grating 102.

The device structures 110 of the intermediate grating 104 have a depth 212. The depth 212 of the device structures 110 of the intermediate grating 104 is a variable depth. The depth 212 of the device structures 110 varies across the portion 212a of the intermediate grating 104. At least two of the device structures 110 are different across the portion 212a. The device structures 110 of the outcoupler grating 106 have a variable depth 213. The depth 213 of the device structures 110 of the outcoupler grating 106 is a variable depth. The depth 213 of the device structures 110 varies across the portion 213b of the outcoupler grating 106. At least two of the device structures 110 are different across the portion 213b. In one example, the change in depth 212 of the device structures 110 of the intermediate grating 104 is different from the change in depth 213 of the device structures 110 of the outcoupler grating 106. In yet another example, the variable depth 212 of the device structures 110 of the intermediate grating 104 is the same as the variable depth 213 of the device structures 110 of the outcoupler grating 106. The device structures 110 are binary structures or angled structures. The angled structures have a planar top surface and slanted sidewalls.

The blazed structures 108 of the incoupler grating 102 have a blazed surface 203. The blazed surface 203 is slanted at a slant angle 204. The slant angle 204 is the angle of the blazed surface 203 to a plane p parallel to the substrate 101. As shown in FIG. 3A, the blazed surface 203 is stepped. In one or more embodiments, The thickness 245 includes the thickness of device material 103 and the depth 202 of the blazed structures 108. In one or more embodiments, the depth 202 is in the range from about 50 nm to about 70 nm, such as 55 nm. In some embodiments, the thickness 253 of the device material 103 is in the range from about 75 nm to about 95 nm, such as about 80 nm.

The device structures 110 of the intermediate grating 104 and outcoupler grating 106 have a duty cycle. The duty cycle of the intermediate grating 104 is the ratio of the width 222a of device structures 110 to the period ∧ of one repeating structure 110. The device structures 110 of the intermediate grating 104 have a width 222a and period ∧. In one or more embodiments, the duty cycle of the device structures 110 of the intermediate grating 104 is a variable duty cycle (i.e., the duty cycle changes across the portion 212a). The duty cycle varies from about 0.1 to about 0.9. The device structures 110 of the outcoupler grating 106 have a width 222b and a period ∧. The duty cycle is the ratio of the width 222b of device structures 110 to the period ∧ of one repeating structure 110. In one or more embodiments, the duty cycle of the device structures 110 of the outcoupler grating 106 is a variable duty cycle (i.e., the duty cycle changes across the portion 213b).

FIG. 2C is a schematic, cross-sectional view of waveguide 100 along line 2-2′ shown in FIG. 1. The waveguide 100 of FIG. 2C has a third configuration 200C. A metal material 207 is disposed over the incoupler grating 102. The blazed structures 108 are etched into the substrate 101. The substrate 101 has a thickness 246. In another embodiment, the thickness 246 of the substrate 101 is in the range from about 0.3 mm to about 1.0 mm, such as 0.6 nm.

The blazed structures 108 have a depth (i.e., an etch depth) 202. In one or more embodiments, the depth 202 is in the range from about 50 nm to about 70 nm, such as 55 nm. In some embodiments, the blazed structures 108 have a variable depth. A variable depth corresponds to the depth 202 of at least two of the blazed structures 108 being different. To form an incoupler grating 102 having a variable depth, the etch depth is non-uniform. The blazed structures 108 of the incoupler grating 102 have a blazed surface 203. The blazed surface 203 is slanted at a slant angle 204. The slant angle 204 is the angle of the blazed surface 203 to a plane p parallel to the substrate 101. The slant angle 204 is in the range from about 5 degrees to about 45 degrees. For example, the slant angle 204 is in the range from about 10 degrees to about 30 degrees. As shown in FIG. 3A, the blazed surface 203 is stepped. As shown in FIG. 3B, the blazed surface 203 is substantially uniform.

The device structures 110 of the intermediate grating 104 have a depth 212. The depth 212 of the device structures 110 of the intermediate grating 104 is a variable depth. The depth 212 of the device structures 110 varies across the portion 212a of the intermediate grating 104. At least two of the device structures 110 are different across the portion 212a. The device structures 110 of the of the outcoupler grating 106 have a variable depth 213. The depth 213 of the device structures 110 of the outcoupler grating 106 is a variable depth. The depth 213 of the device structures 110 varies across the portion 213b of the outcoupler grating 106. At least two of the device structures 110 are different across the portion 213b. In one example, the change in depth 212 of the device structures 110 of the intermediate grating 104 is different from the change in depth 213 of the device structures 110 of the outcoupler grating 106. In yet another example, the variable depth 212 of the device structures 110 of the intermediate grating 104 is the same as the variable depth 213 of the device structures 110 of the outcoupler grating 106. The device structures 110 are binary structures or angled structures. The angled structures have a planar top surface and slanted sidewalls.

The device structures 110 of the intermediate grating 104 and outcoupler grating 106 have a duty cycle. The duty cycle of the intermediate grating 104 is the ratio of the width 222a of device structures 110 to the period ∧ of one repeating structure 110. The device structures 110 of the intermediate grating 104 have a width 222a and period ∧. In one or more embodiments, the duty cycle of the device structures 110 of the intermediate grating 104 is a variable duty cycle (i.e., the duty cycle changes across the portion 212a). The duty cycle varies from about 0.1 to about 0.9. The device structures 110 of the outcoupler grating 106 have a width 222b and a period ∧. The duty cycle is the ratio of the width 222b of device structures 110 to the period ∧ of one repeating structure 110. In one or more embodiments, the duty cycle of the device structures 110 of the outcoupler grating 106 is a variable duty cycle (i.e., the duty cycle changes across the portion 213b).

FIG. 3A is a schematic, cross sectional view of blazed structures 108. The blazed structures 108 have a stepped configuration 300A. The blazed structures 108 of the configurations 200A, 200B, 200C may have a the stepped configuration 300B. The blazed structures 108 of the incoupler grating 102 have a blazed surface 203. The blazed surface 203 is slanted at a slant angle 204. The slant angle 204 is the angle of the blazed surface 203 to a plane p parallel to the substrate 101. As shown in FIG. 3A, the blazed surface 203 is stepped. As shown in FIG. 3B, the blazed surface 203 is substantially uniform.

As shown in FIG. 3A, the blazed structures 108 of the incoupler grating 102 have a top surface 333. The top surface 333 has a width W2. The total thickness of the blazed structures 108 includes thickness 246 of the substrate 101 and depth 202 of the blazed structures 108. The blazed structures 108 of the incoupler grating 102 have a sidewall 326. In one embodiment, the depth 202 of the blazed structures 108 includes the device material 103. In other embodiments, the depth 202 of the blazed structures 108 includes the nano-imprint material 201. In yet another embodiment, the depth 202 of the blazed structures 108 includes the substrate 101. The blazed surface 203 has a plurality of steps 308a. In one embodiment, which can be combined with other embodiments described herein, the blazed surface 203 includes one or more steps.

As shown in FIG. 3B, the blazed structures 108 of the incoupler grating 102 have a top surface 334. The top surface 334 has a width W2. The total thickness of the blazed structures 108 includes thickness 246 of the substrate 101 and depth (i.e., etch depth) 202 of the blazed structures 108. In some embodiments, the blazed structures 108 have a variable depth 202. A variable depth corresponds to the depth 202 of at least two of the blazed structures 108 being different. To form an incoupler grating 102 having a variable depth, the etch depth is non-uniform. In one embodiment, the depth 202 of the blazed structures 108 includes the device material 103. In other embodiments, the depth 202 of the blazed structures 108 includes the nano-imprint material 201. In yet another embodiment, the depth 202 of the blazed structures 108 includes the substrate 101. The thickness 253 of the device material 103 includes the depth 202 of the blazed structures 108. In some embodiments, the thickness 253 of the device material 103 is in the range from about 75 nm to about 95 nm, such as about 80 nm.

The blazed structures 108 of the incoupler grating 102 have a blazed surface 203. The blazed surface 203 is slanted at a slant angle 204. The slant angle 204 is the angle of the blazed surface 203 to a plane p parallel to the substrate 101. As shown in FIG. 3B, the blazed surface 203 is substantially uniform. A trailing sidewall 324 is slanted at slant angle 304. The slant angle 304 is the angle of the trailing sidewall 324 to the plane p parallel to the substrate 101.

Still referring to FIG. 3B, the blazed structures 108 of the incoupler grating 102 have a top duty cycle. The top duty cycle is the ratio of the width W2 to the period ∧_{IC}. In one or more embodiments, the top duty cycle of the blazed structures 108 of the incoupler grating 102 is in the range from about 0.1 to 0.9, such as about 0.3. The blazed structures 108 of the incoupler grating 102 have a bottom duty cycle. The bottom duty cycle is the ratio of the width W1 to the period ∧_{IC}. In one or more embodiments, the bottom duty cycle of the blazed structures 108 of the incoupler grating 102 is in the range from about 0.1 to 0.9, such as about 0.9.

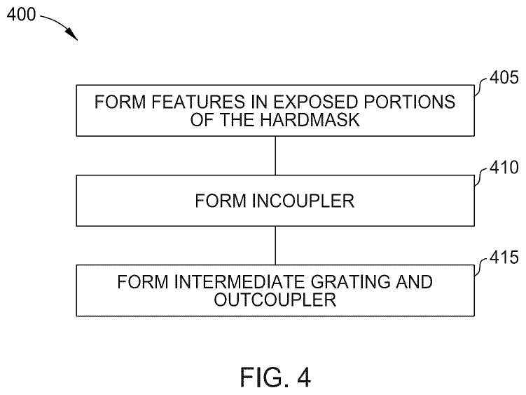

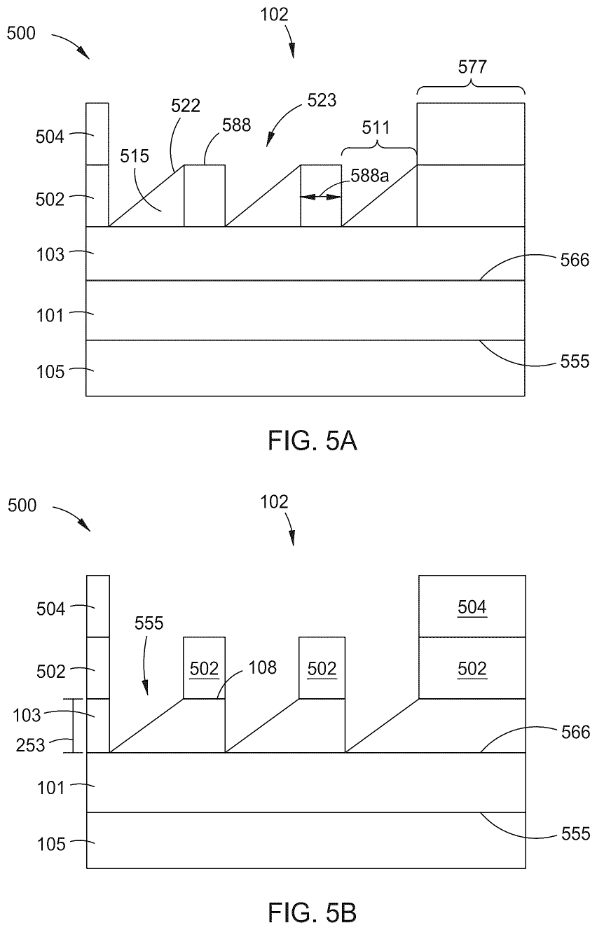

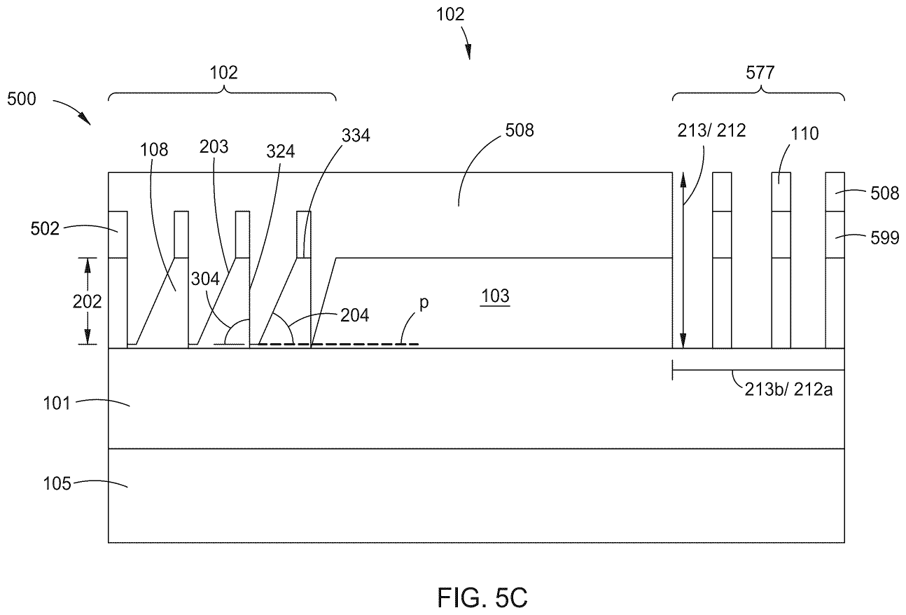

FIG. 4 is a flow diagram of a method 400 of forming a waveguide, according to certain embodiments. FIGS. 5A-5C are schematic, cross sectional views of a portion 500 of a substrate 101 during the method 400. The method 400 includes operations drawn to a litho-etch process. While the operations form the incoupler grating 102, the intermediate grating 104, and the outcoupler grating 106 in the device material 103 of the first configuration 200A. The operations are also applicable to form the incoupler grating 102, the intermediate grating 104, and the outcoupler grating 106 in the substrate 101 of the third configuration 200C.

Prior to operation 405, a device material 103 is deposited over a first side 566 of the substrate 101. In some embodiments, a second-side coating 105 is deposited over a second side 555 of the substrate 101. Examples of deposition methods include a physical vapor deposition (PVD) process (e.g., ion beam sputtering, magnetron sputtering, e-beam evaporation), a chemical vapor deposition (CVD) process, a plasma enhanced chemical vapor deposition (PECVD) process, an atomic layer deposition (ALD) process, an inkjet printing process, or a three-dimensional (3D) printing process.

A hardmask layer 502 is then deposited over the device material 103, or in other embodiments (i.e., the third configuration 200C) the hardmask layer 502 is deposited over the substrate 101. The photoresist layer 504 is deposited over the substrate 101.

The photoresist layer 504 is patterned to expose portions of the hardmask layer 502. The photoresist layer 504 protects a region 577 corresponding to the intermediate grating 104 and the outcoupler grating 106. The exposed portions of the hardmask layer 502 are etched to form hardmask structures 588. The hardmask structures 588 expose portions 511 of the device material 103 (first configuration 200A) or the substrate 101 (third configuration 200C). The portions 511 and the width 588a of the hardmask structures 588 correspond to the period ∧_{IC} of the blazed structures 108 shown in FIG. 3B. The width W2 of the blazed structures 108 correspond to the width of the hardmask structures 588. To etch the hardmask layer 502, the device material 103 or substrate 101 is exposed to an etchant. The etch process is a plasma etch process, reactive ion etching (RIE), or ion etch process. The etchant may include radicals or ion beams. The plasma etch etches through the hardmask layer 502 to form hardmask structures 588 exposing portions 511 of the hardmask layer 502.

At operation 405, features 523 are formed in the exposed portions of the hardmask layer 502. The features are formed by depositing a resist material 515 in the exposed portions 511 of the hardmask layer 502. The resist material 515 may be deposited with the features 523 or the resist material 515 is patterned to form features 523. The features 523 have an angled surface 522. The resist material 515 may be deposited with the features 523 or the resist material 515 is patterned to form features 523. The angled surface 522 defines the slant angle 204 of the blazed surface 203. The hardmask structures 588 may be angled to correspond with the slant angle 304 of the trailing sidewall 324.

At operation 410, as shown in FIG. 5B, the incoupler grating 102 is formed. An etch process is performed to form the blazed structures 108 of the incoupler grating 102. The substrate 101 is exposed to an etchant. The etch process is a plasma etch process, reactive ion etching (RIE), or ion etch process. The etchant may include radicals or ion beams. The features 523 control the etch depth such that the device material 103 or the substrate 101 form the plurality of blazed structures 108 of the incoupler grating 102 (i.e., the etch process is a transfer etch process where the dimensions of the features 523 are transferred to the blazed structures 108. Following operation 410, residual resist material 515 and the photoresist layer 504 are removed.

At operation 415, the intermediate grating 104 and outcoupler grating 106 are formed. The intermediate grating 104 and outcoupler grating 106 are formed by patterning a second photoresist 508. The second photoresist 508 is disposed and patterned exposing a region 577 corresponding to the intermediate grating 104 and the outcoupler grating 106 to be formed. The second photoresist 508 protects the incoupler grating 102. As shown in FIG. 5C, the second photoresist 508 is patterned to form hardmask structures 599 exposing portions of the device material 103. The device material 103 is etched via one or more masking and etching processes (i.e., litho-etch-litho-etch process) to form the device structures 110 of the intermediate grating 104 and outcoupler grating 106 with depth 212/213 varying across 212a/213b. In other embodiments, a grayscale resist is formed in the exposed portions. Then a transfer etch is performed to form the device structures 110 of the intermediate grating 104 and outcoupler grating 106 with depth varying across 212a/213b. Following operation 415, the second photoresist 508 and the photoresist layer 504 are removed.

Overall, embodiments of the present disclosure generally relate to augmented reality waveguides for augmented, virtual, and mixed reality. More specifically, embodiments described herein provide waveguides with large field-of-view and methods of forming the same. The method includes a litho-etch process that allows for different types of device structures to be formed over the same substrate. Blazed structures (i.e., slanted gratings forming a fold grating configuration) are formed as part of the incoupler. Binary structures and angled structures are formed as part of the outcoupler and exit pupil expander. The varying depth and blazed structures of the incoupler grating enable high efficiency and good color uniformity for larger fields-of-view. For example, the waveguides provided herein and method of forming the same enable a field-of-view larger than 40 degrees. The varying types of device structures included on the waveguide provide a large field-of-view fold grating diffractive waveguide to enable world-locked mixed reality applications.

While the foregoing is directed to examples of the present disclosure, other and further examples of the disclosure may be devised without departing from the basic scope thereof, and the scope thereof is determined by the claims that follow.

What is claimed is:

1. A waveguide, comprising:
an incoupler (IC) grating comprising a plurality of blazed structures disposed over a substrate, the plurality of blazed structures having a blazed surface with a slant angle relative to a plane parallel to the substrate;
a metal material disposed over the plurality of blazed structures; and
an intermediate grating and an outcoupler (OC) grating each comprising a plurality of device structures, the plurality of device structures having a variable depth.

2. The waveguide of claim 1, wherein the plurality of device structures are binary structures.

3. The waveguide of claim 1, wherein the plurality of device structures are angled structures.

4. The waveguide of claim 1, wherein the device structures have a variable duty cycle.

5. The waveguide of claim 1, wherein the plurality of blazed structures and the plurality of device structures are disposed in the substrate.

6. The waveguide of claim 1, wherein the plurality of blazed structures and the plurality of device structures are disposed in a device material over the substrate.

7. The waveguide of claim 1, wherein the plurality of blazed structures and the plurality of device structures include a nano-imprint material disposed over a device material, and the device material is disposed over the substrate.

8. The waveguide of claim 1, wherein the intermediate grating is an exit pupil expander or a fold grating.

9. The waveguide of claim 1, wherein the blazed surface is substantially uniform.

10. The waveguide of claim 1, wherein the blazed surface is stepped.

11. A waveguide, comprising:
an incoupler (IC) grating comprising a plurality of blazed structures disposed over a substrate, the plurality of blazed structures having a blazed surface with a slant angle relative to a plane parallel to the substrate;
a metal material disposed over the plurality of blazed structures; and
an outcoupler (OC) grating comprising a plurality of first device structures, the plurality of first device structures having a first variable depth; and
an intermediate grating comprising a plurality of second device structures, the plurality of second device structures having a second variable depth.

12. The waveguide of claim 11, further comprising an encapsulation layer is disposed over the first device structures and over the second device structures.

13. The waveguide of claim 11, wherein the plurality of first device structures and the plurality of second device structures are binary structures.

14. The waveguide of claim 11, wherein the plurality of first device structures and the plurality of second device structures are angled structures.

15. The waveguide of claim 11, wherein the plurality of blazed structures, the plurality of first device structures, and the plurality of second device structures are disposed in a device material over the substrate.

16. The waveguide of claim 11, wherein the first device structures or the second device structures have a variable duty cycle.

17. The waveguide of claim 11, wherein the blazed surface is substantially uniform.

18. The waveguide of claim 11, wherein the blazed surface is stepped.

19. A method of forming a waveguide, comprising:
forming features in exposed portions of a hardmask layer, the features having an angled surface;
forming an incoupler (IC) grating comprising a plurality of blazed structures, the plurality of blazed structures having a blazed surface with a slant angle relative to a plane parallel to a substrate, wherein the angled surface of the features defines the slant angle of the blazed structures; and
forming an intermediate grating and an outcoupler (OC) grating each comprising a plurality of device structures, the plurality of device structures having a variable depth.

20. The method of claim 19, wherein the plurality of blazed structures and the plurality of device structures are disposed in a device material over the substrate.
